(19) United States
(12) Patent Application Publication
(10) Pub. No.: US 2026/0036414 A1
(43) Pub. Date: Feb. 5, 2026

(54) COMPACT MEASURING TAPE HAVING DUAL BRAKES

(71) Applicant: KOMELON CORPORATION, Busan (KR)

(72) Inventors: Dong Hun KANG, Busan (KR); Nam Hoon KANG, Busan (KR); Baek Cheon SHIN, Busan (KR)

(21) Appl. No.: 19/299,190

(22) Filed: Aug. 13, 2025

Related U.S. Application Data
(63) Continuation-in-part of application No. PCT/IB2024/060022, filed on Oct. 12, 2024.

(30) Foreign Application Priority Data
Nov. 29, 2023 (KR) 10-2023-0169475
Jan. 22, 2025 (KR) 10-2025-000943

(51) Int. Cl. G01B 3/1007; G01B 3/1005

(52) U.S. Cl. CPC G01B 3/1007; G01B 2003/1012; G01B 2003/103

(57) ABSTRACT

A measuring tape that has a housing, a reel rotatably mounted inside the housing, and a blade configured to the drawn out through an entrance of the housing includes: an indirect brake configured to lock the reel indirectly through the blade wound around the reel; a direct brake configured to lock the reel directly by pressing against the reel; and a release button exposed outside the housing, wherein locking of the indirect brake and the direct brake with respect to the reel can be simultaneously released by the release button.

### CROSS REFERENCE TO RELATED APPLICATION

The present application is a Continuation-In-Part of PCT/IB2024/060022 filed on Oct. 12, 2024, which claims priority to Korean Patent Application No. 10-2023-0169475, filed on Nov. 29, 2023 and Korean Patent Application No. 10-2025-000943, filed on Jan. 22, 2025, the entire contents of which are incorporated herein for all purposes by this reference.

### BACKGROUND

### Technical Field

The present disclosure relates to a measuring tape and, more specifically, to a measuring tape having dual brakes that include both a manual brake function capable of temporarily fixing a blade exposed outside a housing and an automatic self-locking function.

### Description of the Related Art

A general measuring tape includes a housing, a reel elastically supported inside the housing, a blade coiled around the reel, and an end hook coupled to an end of the blade. A user draws out the blade from the end to which the end hook is coupled for measurement, and can measure the length or distance of an object by pulling it out to a desired length.

In a general measuring tape, the blade drawn out can be retracted into the housing by the elasticity of a spring embedded in the reel. However, in a measuring tape having a self-locking function, the blade drawn out is not retracted into the housing and remains stationary in the extended state. Therefore, in a measuring tape having a self-locking function, the blade can be returned by operating a separate release button or the like.

Japanese Patent Application Publication No. 2008-39732 has been disclosed in relation to a measuring tape having a self-locking function. Referring to FIG. 1, in the Japanese Patent Application Publication, a roller presses the top surface of a blade, the pressing force is increased by the bottom surface of an inclined surface, and the blade is prevented from moving by pressing its top surface with the bottom surface under the center of the roller.

Further, Korean Patent No. 472991 has been disclosed in relation to a measuring tape having a self-locking function. Referring to the Korean Patent, as shown in FIG. 2, a blade passes between a lower roller and an upper roller, and a wedge-shaped stopper is pressed between the upper roller and the blade to prevent the automatically ejected blade from being retracted.

A measuring tape having a self-locking function includes a button for temporarily disabling the self-locking function, but if the button is pressed even slightly, the self-locking function is disabled, which may cause inconvenience of the blade being rapidly retracted. In addition, in measuring tapes having a self-locking function of the related art, the stopper is closely pressed against the blade by a spring. However, such a method may tend to weakening of the self-locking function over time.

### SUMMARY

The present disclosure provides a compact measuring tape having dual brakes that can supplement the self-locking function while reducing the number of components and enabling miniaturization.

The present disclosure provides a compact measuring tape having dual brakes in which a clearance is allowed in the operation for self-locking so that the self-locking function can be disabled only when a button is moved beyond a predetermined depth.

According to an embodiment of the present disclosure for achieving the objectives of the present disclosure described above, a measuring tape having dual brakes according to an embodiment of the present disclosure includes a housing, a reel rotatably mounted inside the housing, and a blade configured to the drawn out through an entrance of the housing, and additionally includes an indirect brake configured to lock the reel indirectly through the blade wound around the reel, and a direct brake configured to lock the reel directly by pressing against the reel, wherein locking of the indirect brake and the direct brake with respect to the reel can be simultaneously released by the release button.

Although both the indirect brake and the direct brake share the commonality of blocking the movement of the reel, the direct brake restricts the movement of the reel in direct contact with the reel, whereas the indirect brake restricts the movement of the reel by coming into contact with the blade wound around the reel, or the like.

The direct brake limits the movement of the adjacent reel, whereby it is possible to reduce the space occupied by the manual brake in the housing of the measuring tape, and the indirect brake provides supplementary limitation to the movement of the reel, whereby it is possible to increase the fixing force of the reel.

The indirect brake may include a fork rod configured to press the blade inside the entrance of the housing, the release button may rotate about a button rotation axis formed in the housing, and the fork rod may have a tendency to rotate about the button rotation axis in a direction in which the fork rod presses a top surface or a bottom surface of the blade.

An end of the fork rod, that is, the fork presses the top surface of the bottom surface of the blade, whereby it is possible to automatically stop the movement of the blade and maintain the blade in a drawn-out state.

The release button and the fork rod may be integrally formed and rotated together about the button rotation axis, whereby it is possible to simplify the operation structure of the button rotation axis. Depending on cases, the release button and the fork rod may be separated from each other and independently rotated about the button rotation axis, an upper end of the fork rod positioned above the button rotation axis may be positioned inside the release button, and a clearance may exist between the release button and the upper end of the fork rod, so when the release button is pressed beyond a predetermined depth, the release button can press the upper end of the fork rod.

If a clearance exists between the release button and the upper end of the fork rod and they are separated from each other, slight movements of the release button are not immediately transmitted to the fork rod, so that self-locking can be released only by a deliberate action.

In addition, when the fork rod and the release button are formed integrally, the self-locking may be repeatedly released and engaged while the blade is drawn out of the housing, and the release button can be moved up and down continuously. Since the release button moves up and down, a sufficient gap must be formed between the release button and the housing, and foreign substances may easily enter the measuring tape through this gap. However, in this embodiment, even if the self-locking is repeatedly released and engaged, the release button does not continuously move up and down but remains stationary, and since the button does not move, the gap between the release button and the housing can be formed to be minimal or almost nonexistent.

As another embodiment, the indirect brake may include a wedge portion that is in close contact with the blade wound on the reel, and a pressing rod connected to one end of the wedge portion and pressing the wedge portion in a direction in which the wedge portion is brought into close contact with the blade.

The release button rotates about a button rotation axis formed in the housing, and the pressing rod can rotate about the button rotation axis. As previously described, the release button and the pressing rod may be formed integrally to rotate together about the button rotation axis. However, the release button and the pressing rod may be separated from each other and rotate about the button rotation axis, and when the release button is pressed beyond a predetermined depth, both the direct brake and the indirect brake can be released.

The direct brake may include a reel fixing button that rotates about the button rotation axis formed in the housing and presses the reel to restrain or release the reel. The reel fixing button may include fixing protrusions protruding toward the outermost rim of the reel, and the fixing protrusions may reinforce the stopping force of the indirect brake while directly pressing the rim of the reel.

If the rotation of the reel fixing button is excessive, the fixing protrusions may move away from the outermost rim of the reel. To prevent this, the release button may include a rising protrusion that supports the lower end of the reel fixing button at a position where the fixing protrusions engage with the outermost rim. The rising protrusion may limit the downward movement range of the reel fixing button, and when the release button is pressed and the rising protrusion is lifted, the reel fixing button may also be lifted together with the release button, thereby allowing the fixing protrusions to be separated from the outermost rim.

When the release button moves beyond a predetermined depth, the indirect brake may be released, and at the same time, the direct brake by the protrusion may also be released.

Although it may be efficient for the reel fixing button to be exposed outside the housing under the front of the release button, it is also possible for the reel fixing button to be formed adjacent to the upper or side portion of the release button through structural modifications.

The pressing rod and the release button may be separated and independently moved. In the related art, the pressing rod and the release button are formed integrally or constantly in contact with each other, so that even a slight movement of the release button could immediately release the self-locking function. In this embodiment, the pressing rod and the release button may be separated so that a slight movement of the release button does not directly result in release of self-locking.

In addition, in the related art, the pressing rod and the release button are integrally formed or always in contact with each other, so that while the blade is drawn out of the housing, engagement and release of self-locking occurs repeatedly, and the release button can continuously move up and down. Further, since the release button moves up and down, a sufficient gap must be formed between the release button and the housing, and foreign substances may easily enter the measuring tape through this gap.

In this embodiment, the pressing rod is separated from the release button, the upper end of the pressing rod positioned above the button rotation axis is positioned inside the release button, and a clearance exists between the release button and the upper end of the pressing rod, so when the release button pressed beyond a predetermined depth, it can come into contact the upper end of the pressing rod. Therefore, even if the self-locking is repeatedly engaged and released while the blade is drawn outside the housing, if the release button remains stationary without moving up and down repeatedly, the gap between the release button and the housing can be minimized or almost eliminated because the button is not moved, whereby it is possible to block foreign substances from entering through the gap.

Above all, even if the release button is unintentionally pressed shallowly while the blade is drawn out, the movement of the button is not transmitted to the pressing rod, so a user can safely and conveniently drawing out the blade.

The release button can be supported by a spring such that a clearance exists between the release button and the upper end of the pressing rod, and a torsion spring mounted around the button rotation axis can be used.

Also, a portion of the rear of the release button can be supported by the torsion spring, and another portion of the rear of the release button can be supported by the upper end of the pressing rod. By arranging the torsion spring and the upper end of the pressing rod side by side along the button rotation axis, the internal space of the housing can be optimized.

The pressing rod is mounted on the button rotation axis, the release button is mounted outside the pressing rod, the reel fixing button can be mounted outside the release button, and the reel fixing button can rotate along the outer surface of the release button.

The compact measuring tap having dual brakes according to the present disclosure can supplement an indirect brake or a self-locking function that weakens over time, reduce the total number of components while implementing dual brakes, and achieve miniaturization of a measuring tape by directly or indirectly braking the outermost rim of the reel with a direct brake.

The compact measuring tap having dual brakes according to the present disclosure can provide a clearance in the operation for self-locking, and the self-locking function can be released only when the release button moves beyond a predetermined depth.

Even if the indirect brake is repeatedly engaged and released while the blade is drawn outside the housing, if the release button remains stationary without moving up and down repeatedly, the gap between the release button and the housing can be minimized or almost eliminated because the button is not moved, whereby it is possible to block foreign substances from entering through the gap.

Further, the direct brake that directly presses the reel can further improve the fixing force of the reel, and in this process, an enhanced brake effect can be achieved even without additional treatment on the surface of the blade.

### BRIEF DESCRIPTION OF THE DRAWINGS

FIGS. 1 and 2 are diagrams for explaining a measuring tape having a self-locking function of the related art;

FIG. 3 is a diagram for explaining a compact measuring tape having dual brakes according to an embodiment of the present disclosure;

FIG. 4 is a diagram for explaining the interior and a clearance of the compact measuring tape having dual brakes of FIG. 3;

FIGS. 5A-5C and 6 are diagrams for explaining the structure and operation of a release button and a reel fixing button of the compact measuring tape having dual brakes;

FIGS. 7A and 7B are diagrams for explaining engaged and released states of self-locking of the compact measuring tape having dual brakes according to an embodiment of the present disclosure;

FIGS. 8A-8B are diagrams for explaining a reel fixing and releasing process of the compact measuring tape having dual brakes according to an embodiment of the present disclosure;

FIGS. 9A and 9B are diagrams for explaining a compact measuring tape having dual brakes according to an embodiment of the present disclosure;

FIGS. 10A-10C are diagrams for explaining the structure and operation of a release button and a reel fixing button of the compact measuring tape having dual brakes of FIGS. 9A-9B;

FIGS. 11A and 11B are diagrams for explaining a compact measuring tape having dual brakes according to an embodiment of the present disclosure;

FIGS. 12A-12C are diagrams for explaining the structure and operation of a release button and a reel fixing button of the compact measuring tape having dual brakes of FIGS. 10A-10C;

FIGS. 13A and 13C are diagrams for explaining a compact measuring tape having dual brakes according to an embodiment of the present disclosure; and

FIGS. 14A-14C are diagrams for explaining the structure and operation of a release button and a reel fixing button of the compact measuring tape having dual brakes of FIGS. 13A and 13B.

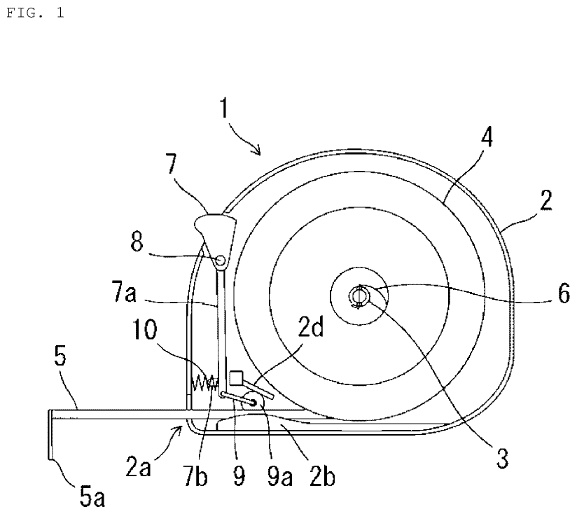

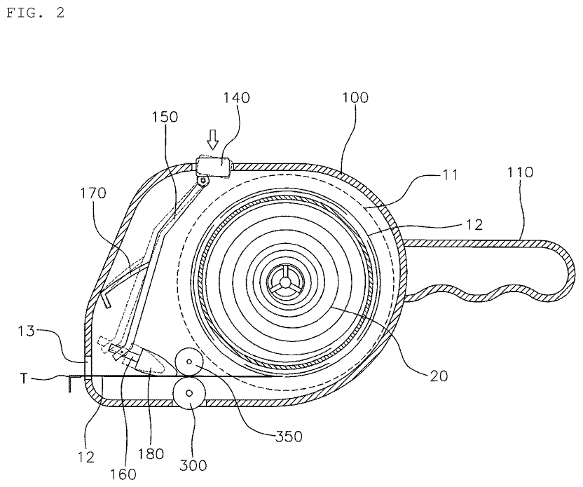

### DETAILED DESCRIPTION

Hereafter, preferred embodiments of the present disclosure will be described in detail with reference to the accompanying drawings, but the present disclosure is not limited or restricted to the embodiments. For reference, the same reference numerals substantially indicate the same components in the description, it is possible to refer to the matters shown in other figures under this rule, and matters that are determined as being apparent or repetitive to those skilled in the art may be omitted.

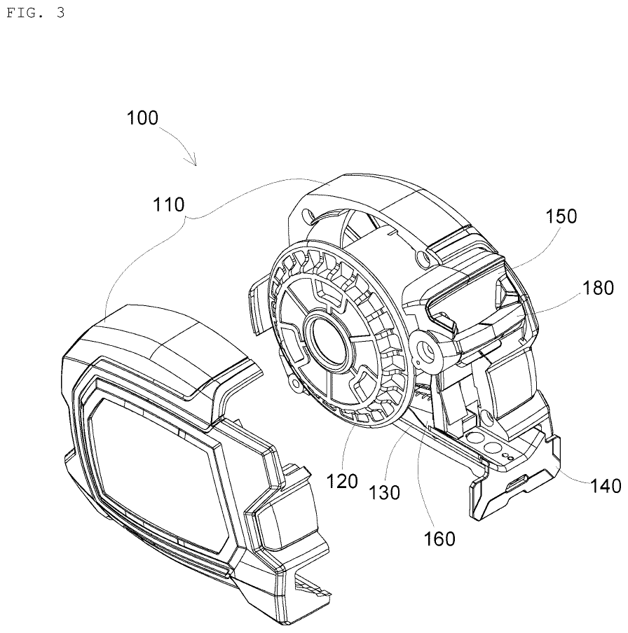

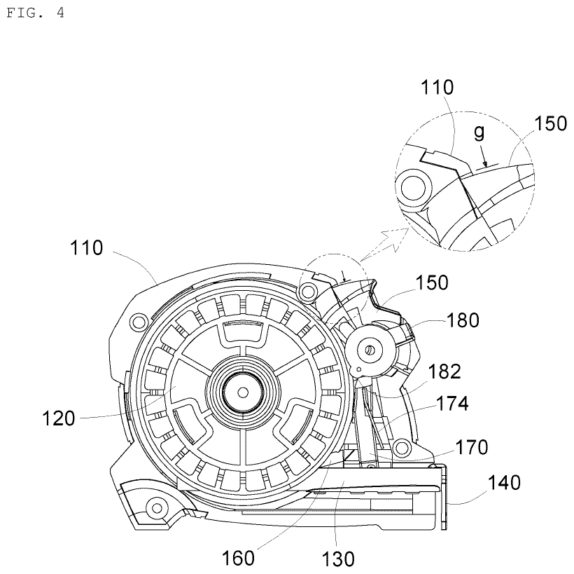

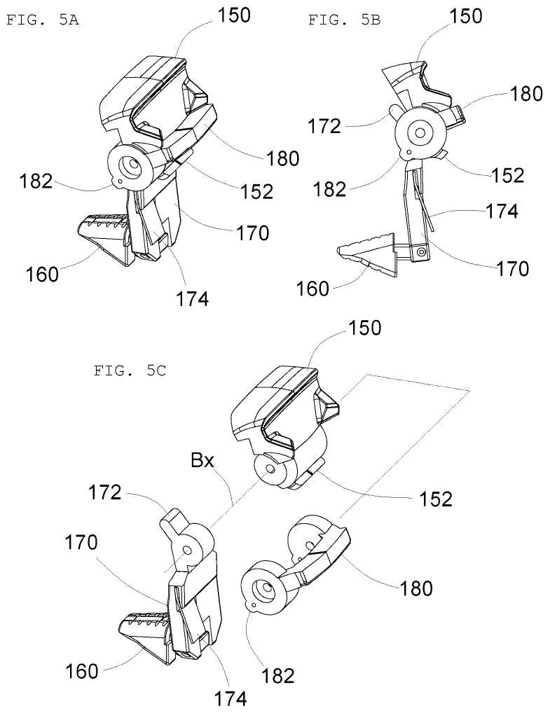

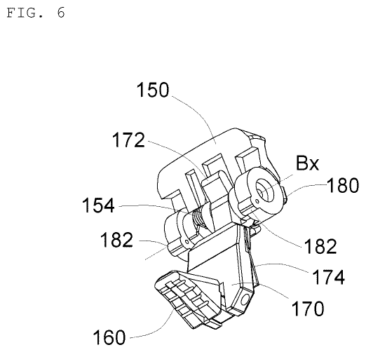

FIG. 3 is a diagram for explaining a compact measuring tape having dual brakes according to an embodiment of the present disclosure, FIG. 4 is a diagram for explaining the interior and a clearance of the compact measuring tape having dual brakes of FIG. 3, and FIGS. 5A-5C and 6 are diagrams for explaining the structure and operation of a release button and a reel fixing button of the compact measuring tape having dual brakes.

Referring to FIGS. 3 to 6, a measuring tape 100 having dual brakes according to this embodiment may fundamentally include a housing 110, a reel 120 rotatably mounted inside the housing 110, a blade 130 configured to be drawn out through an entrance of the housing 110, and an end hook 140 mounted at the end of the blade 130.

In particular, the measuring tape 100 according to this embodiment may include an indirect brake that enters between a portion of the blade 130 wound on the reel 120 and a portion drawn out through the entrance to come into close contact with the blade 130, and a direct brake that directly presses the outer rim of the reel 120.

The indirect brake may include a wedge portion 160 and a pressing rod 170 connected to an end of the wedge portion 160, and the direct brake may include a reel fixing button 180 having fixing protrusions 182 formed thereon. A release button 150 can temporarily separate the wedge portion 160 from the blade 130 in cooperation with an upper end 172 of the pressing rod 170.

The pressing rod 170, the release button 150, and the reel fixing button 180 may be rotatable about a single button rotation axis Bx, and may be mounted on the button rotation axis Bx to perform respective independent functions and, in some cases, may perform interlinked functions. For example, while the blade 130 is drawn out of the housing 110, the pressing rod 170 may perform an independent function. However, if the release button 150 is pressed and moved to press the upper end 172 of the pressing rod 170, the pressing rod 170 may be forcibly separated from the blade 130. In addition, the reel fixing button 180 may perform an independent function of manually fixing the rotation of the reel 120 using the fixing protrusions 182. However, if the release button 150 is pressed and a rising protrusion 152 lifts the bottom surface of the reel fixing button 180, the fixing protrusions 182 of the reel fixing button 180 may be forcibly separated from an outermost rim of the reel 120.

Specifically, the pressing rod 170 is rotatably mounted on the button rotation axis Bx, and the wedge portion 160 is mounted on a lower end thereof. A leaf spring 174 may be mounted between the pressing rod 170 and the housing 110, and the pressing rod 170 can be elastically supported in a direction in which it comes into close contact with the blade 130.

The upper end 172 of the pressing rod 170, opposite to the lower end to which the wedge portion 160 is connected, is positioned on the rear of the release button 150 and is spaced apart from the rear of the release button 150 by a predetermined distance. As shown in FIG. 6, the rear of the release button 150 is constantly supported by a torsion spring 154, so the release button 150 can maintain a predetermined distance from the upper end 172 of the pressing rod 170 and can remain in as close contact with the housing 110 as possible without a gap.

A left of the rear of the release button 150 can be partially supported by the torsion spring 154, and the right of the rear of the release button 150 can be partially supported by the upper end 172 of the pressing rod 170. Since the torsion spring 154 and the upper end 172 of the pressing rod 170 are arranged side by side along the button rotation axis Bx without overlapping, space usage can be minimized.

As shown in the enlarged portion of FIG. 4, the release button 150 has a tendency to remain in close contact with the housing 110, and the gap (g) between the housing 110 and the release button 150 can always be kept to a minimum. Because the release button 150 and the pressing rod 170 are separated, only the pressing rod 170 moves around the button rotation axis Bx even while the blade 130 is drawn out, and the release button 150 can remain stationary, and the gap (g) is kept to a minimum, thereby being able to prevent the inflow of foreign substances.

The release button 150 may be mounted on the button rotation axis Bx to face the upper end 172 of the pressing rod 170. The release button 150 may be elastically supported by the torsion spring 154 or another spring, and may include a rising protrusion 152 protruding forward at its lower portion.

Further, the reel fixing button 180 may be mounted on the button rotation axis Bx to partially surround the release button 150 between the button body of the release button 150 and the rising protrusion 152. The button body of the reel fixing button 180 may be positioned at the front and exposed outside the housing 110, and fixing protrusions 182 may be formed at both ends at opposite positions on the button body.

The fixing protrusions 182 of the reel fixing button 180 can approach the outermost rim of the reel 120 positioned inside, and when the reel fixing button 180 rotates so that the fixing protrusions 182 press the rim of the reel 120, the rotation of the reel 120 can be restricted.

As shown in FIG. 5C, the pressing rod 170 is mounted on the button rotation axis Bx, the release button 150 is mounted outside the pressing rod 170 to cover the upper end 172 of the pressing rod 170, and the reel fixing button 180 may be mounted outside the release button 150 between the button body and the rising protrusion 152. The reel fixing button 180 can rotate between the button body and the rising protrusion 152 along the outer surface of the release button 150, and the fixing protrusions 182 are formed on both inner ends of the reel fixing button 180, respectively, and can come into contact the outermost rim of the reel 120.

Referring to FIG. 3, the button bodies of the release button 150 and the reel fixing button 180 are exposed together at the front upper part of the housing 110. A user can stop the blade 130 at the drawn-out position by performing a simple operation of drawing out the blade 130, and in order to fully or partially retract the blade 130, the user can separate the wedge portion 160 inside from the blade 130 by pressing the release button 150. Further, to more firmly fix the drawn-out state of the blade 130, the user can more firmly restrict the rotation of the reel 120 by pressing the reel fixing button 180 downward.

The button bodies of the release button 150 and the reel fixing button 180 for these operations are arranged together at the front upper part of the housing 110, so a user can easily perform desired operations or functions.

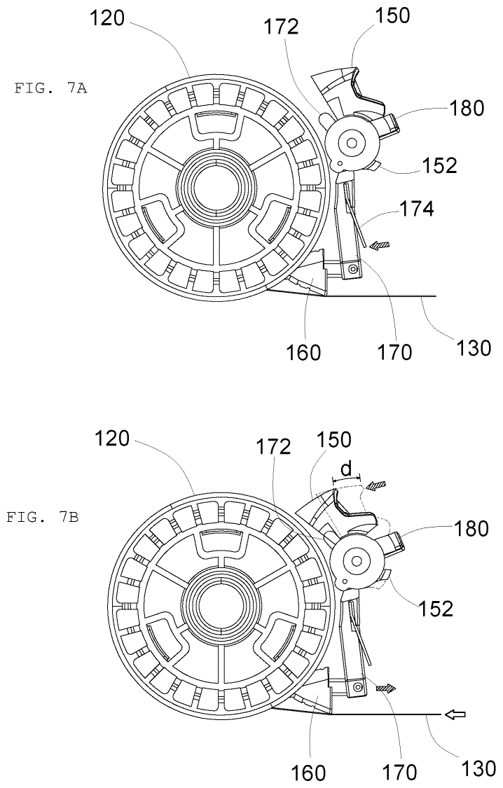

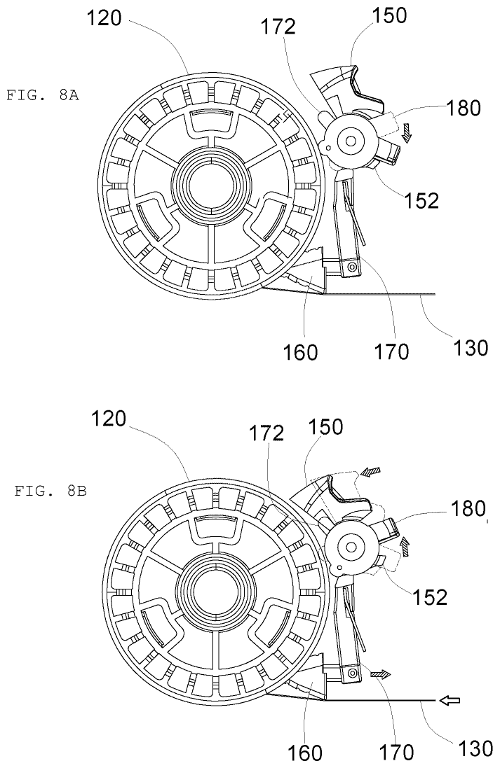

FIGS. 7A and 7B are diagrams for explaining engaged and released states of self-locking of the compact measuring tape having dual brakes according to an embodiment of the present disclosure and FIGS. 8A and 8B are diagrams for explaining a reel fixing and releasing process of the compact measuring tape having dual brakes according to an embodiment of the present disclosure.

Referring to FIG. 7A, when the blade 130 has been drawn out or is being drawn out, the pressing rod 170 is supported by the leaf spring 174, and the wedge portion 160 is connected to the lower end of the pressing rod 170 and can enter between the blade 130 and the reel to be in close contact. The rotation of the reel 120 and the blade 130 can be restricted by the wedge portion 160.

Further, even during the process of drawing out the blade 130, only the wedge portion 160 and the pressing rod 170 can perform the self-locking function while moving left and right, and the release button 150 is separated from the upper end 172 of the pressing rod 170 and can remain stationary.

The fixing protrusions 182 of the reel fixing button 180 are also separated from the rim of the reel 120, so they may not restrict the rotation of the reel 120.

Referring to FIG. 7B, when a user presses the release button 150 to a predetermined depth (d) or more and pushes the upper end 172 of the pressing rod 170, the lower end of the pressing rod 170 and the wedge portion 160 are separated from the blade 130, whereby the blade 130 can be retracted with the rotation of the reel 120.

If the release button 150 is pressed less deeply than the predetermined depth (d), the upper end 172 of the pressing rod 170 is not pressed, so the self-locking function can be maintained. That is, by intentionally separating the release button 150 and the upper end of the pressing rod 170, it is possible to prevent the self-locking from being disabled even through the release button 150 is slightly pressed or shaken.

When the pressing force on the release button 150 is removed, the release button 150 returns to its original position by the torsion spring 154, and the release button 150 can separate by a predetermined distance from the upper end 172 of the pressing rod 170 and remain stationary.

Referring to FIG. 8A, a state is shown in which the reel fixing button 180 is pressed downward and the fixing protrusions 182 press the rim of the reel 120. This may be a state in which a user has pressed down the reel fixing button 180 from the state shown in FIG. 7A.

Basically, in the state where the self-locking function is implemented by the wedge portion 160 and the pressing rod 170, the fixed tape measure can be more stably maintained by additionally reinforcing the fixing by the reel fixing button 180.

The downward movement range of the reel fixing button 180 can be limited by the rising protrusion 152 of the release button 150, and as the reel fixing button 180 moves to the boundary limited by the rising protrusion 152, the fixing protrusion 182 can also naturally move to the angle at which it presses the rim of the reel 120 to the maximum.

Referring to FIG. 8B, a user can press the upper end 172 of the pressing rod 170 and lift the reel fixing button 180 through the rising protrusion 152 by pressing the release button 150. Before the release button 150 is pressed down beyond a predetermined depth, the fixing protrusions 182 of the reel fixing button 180 are separated from the rim of the reel 120. As the release button 150 is pressed beyond the certain depth, the fixing protrusions 182 are completely separated from the reel 120, and the upper end 172 of the pressing rod 170 can be pressed by the release button 150.

That is, even while the locking by the reel fixing button 180 is maintained, a single pressing action of the release button 150 can simultaneously releasing the locking by the reel fixing button 180 and the self-locking by the wedge portion 160.

In this embodiment, since the pressing rod 170, the release button 150, and the reel fixing button 180 are fixed on a single button rotation axis Bx, the installation space can be minimized, and by directly fixing or releasing the reel 120, the minimum locking effect can be provided with minimal force. In addition, it is possible to further enhance the fixing force of the reel by additional forming frictional resistance surfaces or protrusions on the surface of the rim of the reel 120 or the fixing protrusion 182, and it is possible to achieve improved effects without applying additional treatment to the surface of the blade in the process.

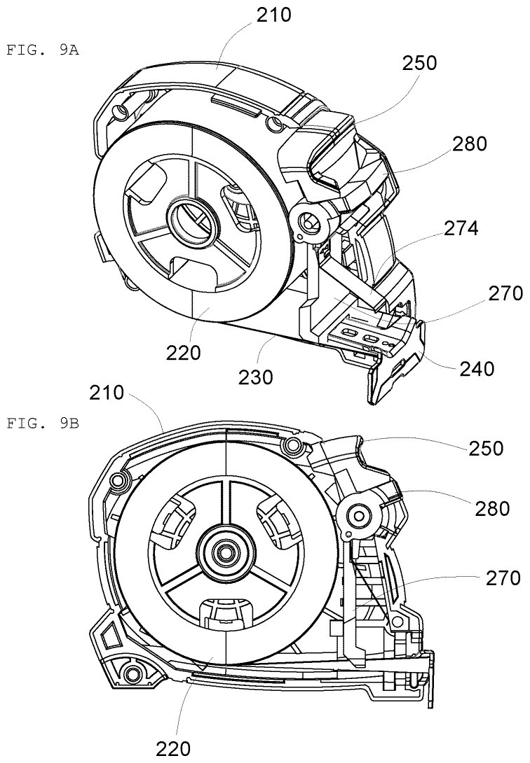

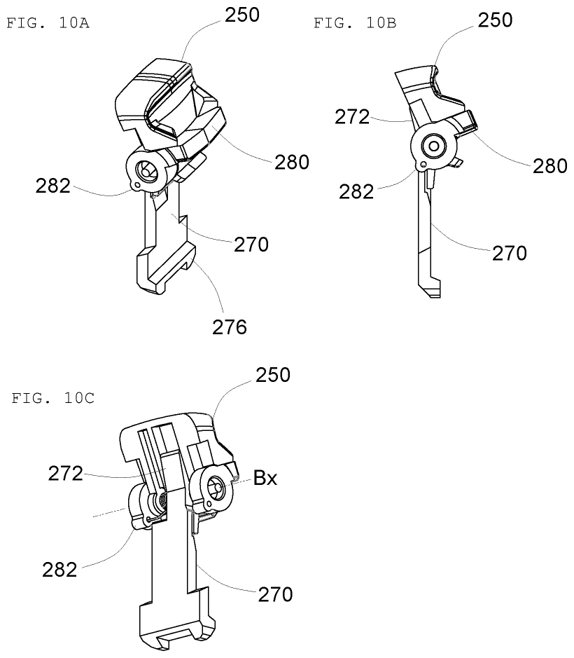

FIGS. 9A and 9B are diagrams for explaining a compact measuring tape having dual brakes according to an embodiment of the present disclosure and FIGS. 10A-10C are diagrams for explaining the structure and operation of a release button and a reel fixing button of the compact measuring tape having dual brakes of FIGS. 9A and 9B.

Referring to FIGS. 9A to 10C, a measuring tape having dual brakes according to this example may fundamentally include a housing 210, a reel 220 rotatably mounted inside the housing 210, a blade 230 configured to be drawn out through an entrance of the housing 210, and an end hook 240 mounted at the end of the blade 230.

The measuring tape may include an indirect brake that presses the top surface of the blade 230 to the reel 220 using an end of a fork rod 270, and a direct brake that directly presses the outer rim of the reel 220.

The indirect brake may include a fork rod 270 having a fork 276 formed at an end thereof, and the direct brake may include a reel fixing button 280 having fixing protrusions 282 formed thereon. A release button 250 can temporarily separate the fork 276 from the top surface of the blade 130 in cooperation with an upper end 272 of the fork rod 270.

The fork rod 270, the release button 250, and the reel fixing button 280 may be rotatable about a single button rotation axis Bx, and may be mounted on the button rotation axis Bx to perform respective independent functions. While the blade 230 is drawn out of the housing 210, the fork rod 270 may perform its independent function. However, if the release button 250 is pressed and presses the upper end 272 of the fork rod 270, the fork 276 may be forcibly separated from the blade 230. A leaf spring 274 may be mounted between the fork rod 270 and the housing 210, and the fork rod 270 can be elastically supported in a direction in which it comes into close contact with the blade 230.

The reel fixing button 280 may perform an independent function of manually fixing the rotation of the reel 220 using the fixing protrusions 282. However, if the release button 250 is pressed and a rising protrusion lifts the bottom surface of the reel fixing button 280, the fixing protrusions 282 of the reel fixing button 280 may be forcibly separated from an outermost rim of the reel 220.

As shown in FIG. 10C, the upper end 272 of the fork rod 270 is positioned on the rear of the release button 250 and is spaced apart from the rear of the release button 250 by a predetermined distance. The rear of the release button 250 is supported by a torsion spring, so that the release button 250 can maintain a predetermined distance from the upper end 272 of the fork rod 270 and can remain in as close contact with the housing 210 as possible without a gap.

Because the release button 250 and the fork rod 270 are separated, only the fork rod 270 moves around the button rotation axis Bx even while the blade 230 is drawn out, and the release button 250 can remain stationary, and the gap between the button and the housing can be maintained at a predetermined level.

A rising protrusion protruding forward is formed at the lower portion of the release button 250. The reel fixing button 280 may be rotatably mounted on the button rotation axis Bx between the button body of the release button 250 and the rising protrusion. The button body of the reel fixing button 280 is positioned at the front and may be exposed outside the housing 210.

The fixing protrusion 282 of the reel fixing button 280 can approach the outermost rim of the reel 220 positioned inside, and when the reel fixing button 280 rotates so that the fixing protrusions 282 comes into contact with and press the rim of the reel 220, the rotation of the reel 220 can be restricted.

A user can stop and maintain the blade 230 in the drawn-out state by performing a simple operation of drawing out the blade 230, and in order to fully or partially retract the blade 230, the user can separate the fork 276 inside from the blade 230 by pressing the release button 250. Further, to more firmly fix the drawn-out state of the blade 230, the user can directly restrict the rotation of the reel 220 by pressing the reel fixing button 280 downward.

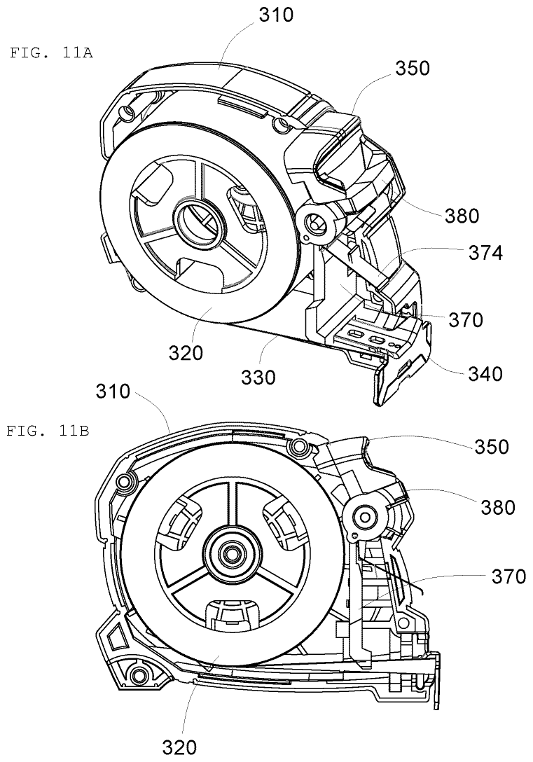

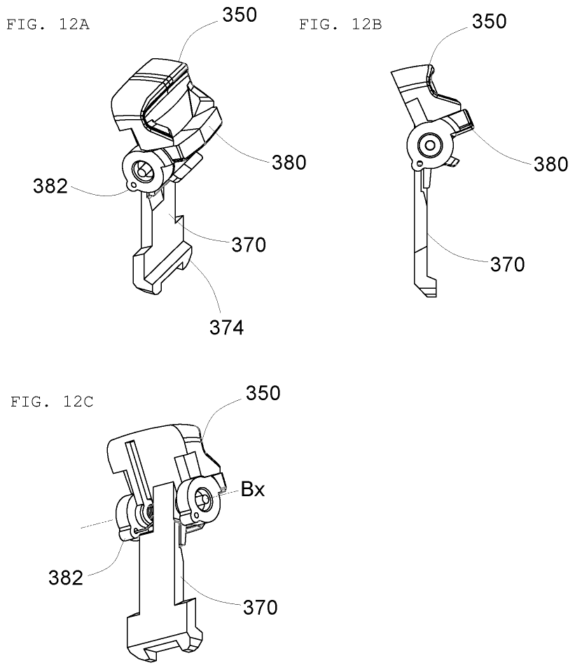

FIGS. 11A and 11B are diagrams for explaining a compact measuring tape having dual brakes according to an embodiment of the present disclosure and FIGS. 12A-12C are diagrams for explaining the structure and operation of a release button and a reel fixing button of the compact measuring tape having dual brakes of FIGS. 11A and 11B.

Referring to FIGS. 11A to 12C, a measure tape having dual brakes according to this embodiment basically includes a housing 310, a reel 320, a blade 330, and an end hook 340, and may include an indirect brake that presses the top surface of the blade 330 and a direct brake that directly presses the outer rim of the reel 320 as brakes for fixing the reel.

The indirect brake may include a fork rod 370 having a fork 376 formed at an end thereof, and the direct brake may include a reel fixing button 380 having fixing protrusions 382 formed thereon. Unlike the previous embodiments, the release button 350 is integrally formed with the fork rod 370 and can temporarily separate the end of the fork rod 370 from the top surface of the blade 330 while moving together.

The fork rod 370, the release button 350, and the reel fixing button 380 may rotate around a single button rotation axis Bx, and while the blade 330 is drawn out of the housing 310, the fork rod 370 can be supported by a leaf spring 374 and maintain the drawn-out state of the blade 330 in a locked state. When the release button 350 is pressed and the end of the fork rod 370 is separated from the blade 330, the blade 330 can be retracted into the housing 310 while winding around the reel 320.

The reel fixing button 380 may perform an independent function of manually fixing the rotation of the reel 320 using the fixing protrusions 382. However, if the release button 350 is pressed and a rising protrusion lifts the bottom surface of the reel fixing button 380, the fixing protrusions 382 of the reel fixing button 380 may be forcibly separated from an outermost rim of the reel 320.

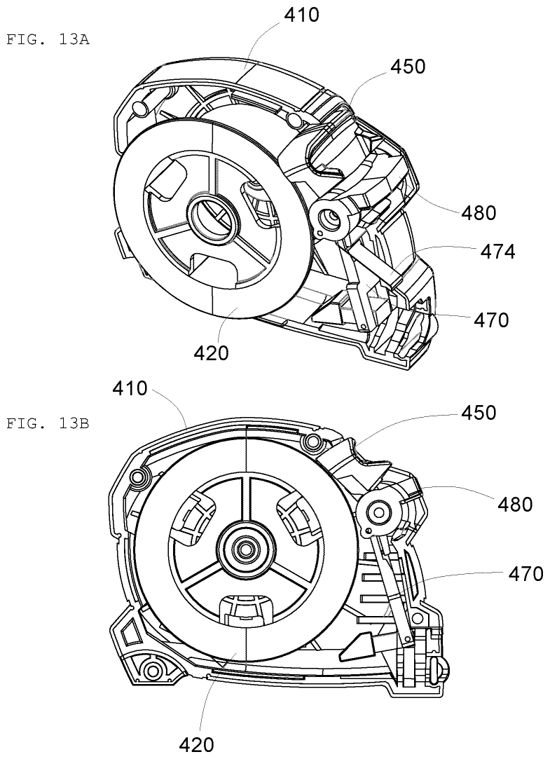

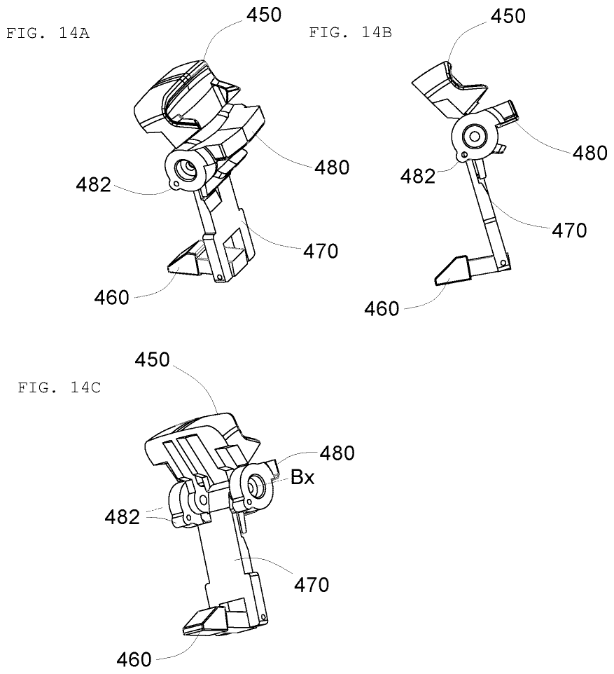

FIGS. 13A and 13B are diagrams for explaining a compact measuring tape having dual brakes according to an embodiment of the present disclosure and FIGS. 14A-14C are diagrams for explaining the structure and operation of a release button and a reel fixing button of the compact measuring tape having dual brakes of FIGS. 13A and 13B.

Referring to FIGS. 13A to 14C, a measure tape having dual brakes according to this embodiment basically includes a housing 410, a reel 420, blades 430, and an end hook 440, and may include an indirect brake that approaches between the blades 430 and pressing them and a direct brake that directly presses the outer rim of the reel 420 as brakes for fixing the reel.

The indirect brake may include a pressing rod 470 having a wedge portion 460 mounted at an end thereof, and the direct brake may include a reel fixing button 480 having fixing protrusions 480 formed thereon. Unlike the previous embodiments, the release button 450 is integrally formed with the pressing rod 470 and can temporarily separate the wedge portion 460 from the blade 460 while integrally moving with the pressing rod 470.

The pressing rod 470, the release button 450, and the reel fixing button 480 may rotate around a single button rotation axis Bx, and while the blade 430 is drawn out of the housing 410, the pressing rod 470 can be supported by a leaf spring 474 and maintain the drawn-out state of the blade 430 in a locked state. When the release button 450 is pressed and the pressing rod 470 and the wedge portion 460 are separated from the blade 460, the blade 430 can be retracted into the housing 410 while winding around the reel 420.

The reel fixing button 480 may perform an independent function of manually fixing the rotation of the reel 420 using the fixing protrusions 482. However, if the release button 450 is pressed and a rising protrusion lifts the bottom surface of the reel fixing button 480, the fixing protrusions 482 of the reel fixing button 480 may be forcibly separated from an outermost rim of the reel 420.

Although exemplary embodiments of the present disclosure were described above with reference to the drawings, it should be understood that the present disclosure may be changed and modified in various ways by those skilled in the art without departing from the spirit and scope of the present disclosure described in claims.

What is claimed is:

1. A measuring tape that has a housing, a reel rotatably mounted inside the housing, and a blade configured to the drawn out through an entrance of the housing, the measuring tape comprising:
an indirect brake configured to lock the reel indirectly through the blade wound around the reel;
a direct brake configured to lock the reel directly by pressing against the reel; and
a release button exposed outside the housing,
wherein locking of the indirect brake and the direct brake with respect to the reel is simultaneously released by the release button.

2. The measuring tape of claim 1, wherein the indirect brake includes a fork rod configured to press the blade inside the entrance of the housing.

3. The measuring tape of claim 2, wherein the release button rotates about a button rotation axis formed in the housing, and the fork rod has a tendency to rotate about the button rotation axis in a direction in which the fork rod presses a top surface or a bottom surface of the blade.

4. The measuring tape of claim 3, wherein the release button and the fork rod are integrally formed and rotated together about the button rotation axis.

5. The measuring tape of claim 3, wherein the release button and the fork rod are separated from each other and rotated about the button rotation axis, an upper end of the fork rod positioned above the button rotation axis is positioned inside the release button, and a clearance exists between the release button and the upper end of the fork rod, so when the release button is pressed beyond a predetermined depth, the release button comes into contact with the upper end of the fork rod.

6. The measuring tape of claim 1, wherein the indirect brake includes a wedge portion that is in close contact with the blade wound on the reel, and a pressing rod connected to one end of the wedge portion and pressing the wedge portion in a direction in which the wedge portion is brought into close contact with the blade.

7. The measuring tape of claim 6, wherein the release button rotates about a button rotation axis formed in the housing, and the pressing rod rotates about the button rotation axis.

8. The measuring tape of claim 7, wherein the release button and the pressing rod are integrally formed and rotate together about the button rotation axis.

9. The measuring tape of claim 7, wherein the release button and the pressing rod are separated from each other and rotated about the button rotation axis, and an upper end of the pressing rod positioned above the button rotation axis is positioned inside the release button, and a clearance exists between the release button and the upper end of the pressing rod, so when the release button is pressed beyond a predetermined depth, the release button comes into contact with the upper end of the pressing rod.

10. The measuring tape of claim 9, wherein while the blade is drawn out, the release button remains stationary, and a gap between the release button and the housing is constant.

11. The measuring tape of claim 9, wherein the release button is supported by a spring so that a clearance exists between the release button and the upper end of the pressing rod.

12. The measuring tape of claim 11, wherein the release button is supported by a torsion spring with respect to the button rotation axis, and the torsion spring and the upper end of the pressing rod are arranged side by side along the button rotation axis inside the release button.

13. The measuring tape of claim 1, wherein the direct brake includes a reel fixing button configured to rotate about a button rotation axis formed in the housing and to restrict or release the reel by pressing the reel, and
when the release button is moved beyond a predetermined depth, the real fixing button releases the reel.

14. The measuring tape of claim 13, wherein the reel fixing button includes fixing protrusions protruding toward an outermost rim of the reel, the release button includes a rising protrusion that supports a lower end of the reel fixing button at a position where the fixing protrusions mesh with the outermost rim, the rising protrusion limits the range of downward movement of the reel fixing button, and when the release button is pressed and the rising protrusion is lifted, the reel fixing button moves together with the release button and the fixing protrusions are separated from the outermost rim.

15. The measuring tape of claim 13, wherein the reel fixing button is exposed from the housing under a front of the release button.
